(19) United States
(12) Patent Application Publication
(10) Pub. No.: US 2006/0125749 A1
(43) Pub. Date: Jun. 15, 2006

(54) Display device and driving method thereof

(75) Inventors: Seung-Kyu Lee, Yongin-si (KR); Won-Sang Park, Yongin-si (KR); Kee-Han Uh, Yongin-si (KR); Hae-Young Yun, Suwon-si (KR); Jae-Hyun Kim, Suwon-si (KR); Sang-Woo Kim, Suwon-si (KR); Ki-Hun Jeong, Seoul (KR); Sung-Eun Cha, Geoje-si (KR); Irina Poundaleva, Yongin-si (KR); Jae-Young Lee, Yongin-si (KR); Jae-Ik Lim, Chuncheon-si (KR); Young-Joo Chang, Suwon-si (KR)

Correspondence Address: MacPherson Kwok Chen & Heid LLP, Suite 226, 1762 Technology Drive, San Jose, CA, 95110, US

(73) Assignee: SAMSUNG ELECTRONICS CO., LTD., Suwon-si (KR)

(21) Appl. No.: 11/304,413

(22) Filed: Dec. 14, 2005

(30) Foreign Application Priority Data
Dec. 14, 2004 (KR) 10-2004-0105549

(51) Int. Cl. G09G 3/36

(52) U.S. Cl. 345/88

(57) ABSTRACT

Disclosed is a display device with a driving method thereof. The display device includes a plurality of gate lines, a plurality of data lines crossing the gate lines for transmitting gray voltages corresponding to image data among a plurality of the gray voltages as data voltages, and a plurality of pixels connected to the gate and the data lines for receiving the data voltages. The pixels include first color pixels, second color pixels, and third color pixels. The first color pixels express a maximum luminance upon application of a first voltage having the maximum value among the gray voltages, and the second and the third color pixels express a maximum luminance upon application of second and third voltages less than the first voltage among the gray voltages.

### BACKGROUND OF THE INVENTION

(a) Field of the Invention

The present invention relates to a display device, and a method of driving the display device.

(b) Description of the Related Art

A liquid crystal display (“LCD”) includes two display panels having pixel and common electrodes, and a liquid crystal layer having a dielectric anisotropy disposed between the panels. The pixel electrodes are arranged in the form of a matrix, and are connected to switching elements such as thin film transistors to sequentially receive data voltages per pixel row. The common electrode receiving a common voltage extends over substantially the entire surface of one of the panels. From a circuit perspective, the pixel and the common electrodes and the liquid crystal layer disposed therebetween form a liquid crystal capacitor. The capacitor together with a switching element connected thereto form a basic unit for a pixel.

The LCD generates an electric field in the liquid crystal layer by applying voltages to the two electrodes, and adjusts the intensity of the electric field to control the transmittance of light passing through the liquid crystal layer, thereby displaying the desired images. In order to prevent the liquid crystal layer from deteriorating due to extended application of the unidirectional electric field, the polarity of the data voltage with respect to the common voltage is inverted, e.g., per frame, pixel row, or pixel.

Several efforts have been recently made to enhance the color shift or gamma correction of the LCD. With a vertical electric field mode, such as a vertical alignment (“VA”) mode, an electrically controlled birefringence (“ECB”) mode and a twisted nematic (“TN”) mode, such a color shift is necessarily made within the gray region while providing the driving voltage. Two methods of solving such a problem are used together. One method is to make an optical design of a liquid crystal panel based on a blue color B, and the other method is to convert the image data, as is done for accurate color compensation (“ACC”) or dynamic gamma adjustments. Although the co-usage of the two methods may be effective in minimizing the color shift or making the gamma correction, the overall luminance of the panel can be reduced by about 20%.

As shown in FIG. 3, when the optical design is made based on the blue B, the maximum gray voltage should be 3V, which corresponds to the point where the luminance of the blue B is maximized. However, at this voltage level, the blue B pixel expresses nearly 100% of luminance, but the green G pixel expresses only 80% of luminance and the red R pixel expresses only 60% of luminance. Consequently, the overall luminance loss amounts to 20%, and the color representation is deteriorated.

Even though the optical design is made based on the overall luminance of the red R, the green G, and the blue B, and the maximum gray voltage is established to be 3.4V, some luminance loss still occurs.

### SUMMARY OF THE INVENTION

A display device and a method of driving the display device are provided which minimize the color shift and expresses the maximum luminance while making gamma corrections and fully representing colors.

In accordance with embodiments of the present invention, a display device with the following features is provided together with a driving method thereof.

According to one aspect of the present invention, a display device includes a plurality of gate lines, a plurality of data lines crossing the gate lines for transmitting gray voltages as data voltages corresponding to image data, said gray voltages selected from a plurality of the gray voltages, and a plurality of pixels coupled to the gate and the data lines for receiving the data voltages. The pixels include first color pixels, second color pixels, and third color pixels. The first color pixels express a maximum luminance upon application of a first voltage having the maximum value among the gray voltages, and the second and the third color pixels express a maximum luminance upon application of second and third voltages less than the first voltage.

The plurality of gray voltages include a set of first, second and third gray voltages having maximum values of the first, the second and the third voltages, respectively.

The display device may further include a signal controller for receiving and signal-processing the image data and transmitting the processed data, and a data driver for receiving and converting the processed data from the signal controller into the data voltages for application to the data lines.

The first color pixels may be red pixels.

The display device may further include a gray voltage generator for generating and applying the first to the third voltages to the data driver.

The data driver may include first to third digital-analog converters for generating the first to the third gray voltages based on the first to the third voltages from the gray voltage generator, respectively.

The image data may include first to third image data corresponding to the respective first to third color pixels, and the number of gray values corresponding to the second and the third image data may be less than the number of gray values corresponding to the first image data.

The display device may further include a gray voltage generator for generating and applying the first voltage to the data driver, and the data driver may include a digital-analog converter for converting the processed first to third image data into the data voltages based on the first voltage from the gray voltage generator.

The display device may include a data corrector for correcting the second and the third image data each with the maximum gray value into first and second gray data corresponding to the second and the third voltages, respectively.

The data corrector may relates the second and the third image data to a single gray data.

The data corrector may include a lookup table providing a correspondence relation between the second and third image data and the gray data.

The data corrector may correct and dithering-process the second and the third image data such that the second and the third image data have an output gray range less than the input gray range.

According to another aspect of the present invention, a method of driving a display device with a plurality of first to third color pixels includes the steps of: generating a plurality of gray voltages; receiving and signal-processing first to third image data corresponding to the respective first to third color pixels from the outside; and applying gray voltages as data voltages corresponding to the first to the third image data, said gray voltages being selected from a plurality of the gray voltages. The first color pixels express a maximum luminance upon application of a first voltage having a maximum value among the gray voltages, and the second and the third color pixels express a maximum luminance upon application of second and third voltages less than the first voltage among the gray voltages.

The gray voltage generating step may include the sub-step of generating first to third gray voltages with the maximum values of the first to the third voltages, respectively.

The image data processing step may include the sub-step of correcting the second and the third image data each with the maximum gray value into first and second gray data corresponding to the second and the third voltages, respectively.

### BRIEF DESCRIPTION OF THE DRAWINGS

The present invention will become more apparent from the following detailed description of the embodiments thereof with reference to the accompanying drawings in which:

FIG. 1 is a block diagram of an LCD according to an embodiment of the present invention;

FIG. 2 is an equivalent circuit diagram of a pixel of an LCD according to an embodiment of the present invention;

FIG. 3 is a graph illustrating the luminance characteristic of an LCD according to an embodiment of the present invention;

FIG. 4 is a block diagram of a data driver of an LCD according to an embodiment of the present invention;

FIG. 5 is a block diagram of a data corrector and a data driver of an LCD according to another embodiment of the present invention;

FIG. 6 is a graph illustrating the gamma curve with respect to a red color according to another embodiment of the present invention; and

FIG. 7 illustrates a way of expressing 8 bits of conversion data with 6 bits of corrected image data according to another embodiment of the present invention.

### DETAILED DESCRIPTION OF PREFERRED EMBODIMENTS

The present invention now will be described more fully hereinafter with reference to the accompanying drawings, in which preferred embodiments of the invention are shown. The present invention may, however, be embodied in many different forms and should not be construed as limited to the embodiments set forth herein.

In the drawings, the thickness of layers, films and regions are exaggerated for clarity. Like numerals refer to like elements throughout. It will be understood that when an element such as a layer, film, region or substrate is referred to as being “on” another element, it can be directly on the other element or intervening elements may also be present. In contrast, when an element is referred to as being “directly on” another element, there are no intervening elements present.

LCDs and driving methods thereof according to embodiments of the present invention will be described in detail below with reference to the accompanying drawings.

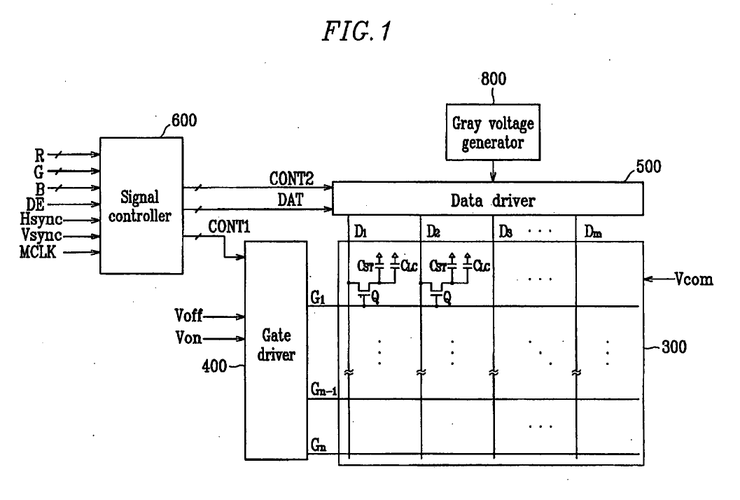

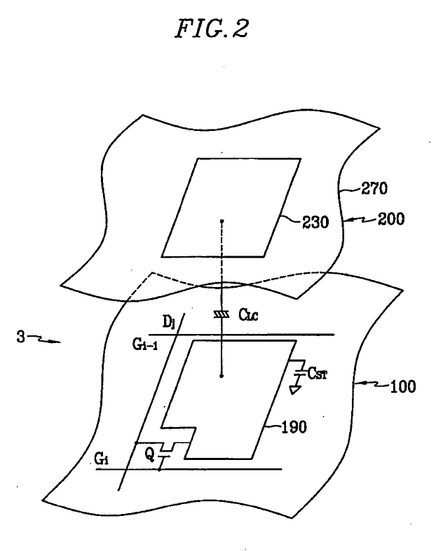

FIG. 1 is a block diagram of an LCD according to an embodiment of the present invention, and FIG. 2 is an equivalent circuit diagram of a pixel of an LCD according to an embodiment of the present invention.

As shown in FIG. 1, an LCD according to an embodiment of the present invention includes a liquid crystal panel assembly 300, a gate driver 400, a data driver 500, a gray voltage generator 800 connected to the data driver 500, and a signal controller 600 for controlling the gate driver 400, the data driver 500, and the gray voltage generator 800.

From an equivalent circuit perspective, the liquid crystal panel assembly 300 includes a plurality of display signal lines G1-Gn and D1-Dm, and a plurality of pixels arranged in the form of a matrix.

The display signal lines G1-Gn and D1-Dm include a plurality of gate lines G1-Gn for transmitting gate signals (also called the “scanning signals”) and data lines D1-Dm for transmitting data signals. The gate lines G1-Gn extend in parallel in the direction of pixel rows, and the data lines D1-Dm extend in parallel in the direction of pixel columns.

The respective pixels include a switching element Q connected to the display signal lines G1-Gn and D1-Dm, and a liquid crystal capacitor C_{LC} and a storage capacitor C_{ST} connected to the switching element Q. The storage capacitor C_{ST} may be omitted in some embodiments.

The switching element Q such as a thin film transistor may be provided in a lower panel 100, and has a triode structure with control and input terminals connected to the gate lines G1-Gn and the data lines D1-Dm, respectively, and an output terminal connected to the liquid crystal capacitor C_{LC} and the storage capacitor C_{ST}.

The liquid crystal capacitor C_{LC} is coupled to a pixel electrode 190 of the lower panel 100 and a common electrode 270 of an upper panel 200 as two terminals, and a liquid crystal layer disposed between the two electrodes 190 and 270 functions as a dielectric. The pixel electrode 190 is coupled to the switching element Q, and the common electrode 270 is formed on the entire surface of the upper panel 200 to receive a common voltage Vcom. In other embodiments, the common electrode 270 may be provided on the lower panel 100, and in this case, at least one of the two electrodes 190 and 270 may be formed in the shape of a line or a bar.

The storage capacitor C_{ST} subsidiary to the liquid crystal capacitor C_{LC} is formed by overlapping the pixel electrode 190 with a separate signal line (not shown) provided on the lower panel 100 while interposing an insulator. A predetermined voltage such as a common voltage Vcom is applied to the separate signal line. Alternatively, the storage capacitor C_{ST} may be formed by overlapping the pixel electrode 190 with the previous gate line for an adjacent pixel while interposing an insulator therebetween.

Meanwhile, in order to express colors, the respective pixels should intrinsically express one of the primary colors (spatial division), or alternately express the primary colors in temporal order (time division) such that the desired colors can be perceived from the spatial or temporal sum of the primary colors. FIG. 2 shows an example of the spatial division where each pixel has color filters 230 of red, green and blue at the region corresponding to the pixel electrode 190. In other embodiments, the color filter 230 may be formed on the lower panel 100 on top of or below the pixel electrode 190.

A polarizer (not shown) is attached to the outer surface of at least one of the two panels 100 and 200 of the liquid crystal panel assembly 300 to polarize light.

The gray voltage generator 800 generates two sets of gray voltages related to the pixel transmittance. One set of gray voltages have a positive value with respect to the common voltage Vcom, and the other set of gray voltages have a negative value with respect thereto.

The gate driver 400 is connected to the gate lines G1-Gn of the liquid crystal panel assembly 300 to apply gate signals to the gate lines G1-Gn. The gate signals are formed with combinations of gate on and off voltages Von and Voff.

The data driver 500 is connected to the data lines D1-Dm of the liquid crystal panel assembly 300 to select gray voltages from the gray voltage generator 800 and apply them to the pixels as data signals.

The gate driver 400 or the data driver 500 may be directly mounted on the liquid crystal panel assembly 300 in the form of a plurality of driving integrated circuit chips, or mounted on a flexible printed circuit film (not shown) and attached to the liquid crystal panel assembly 300 in the form of a tape carrier package TCP. Alternatively, the gate driver 400 or the data driver 500 may be integrated on the liquid crystal panel assembly 300.

The signal controller 600 controls the operation of the gate driver 400 and the data driver 500.

The display operation of the LCD will be explained in detail below.

The signal controller 600 receives from an external graphic controller (not shown) input image signals R, G, and B and input control signals, such as vertical synchronization signals Vsync, horizontal synchronization signals Hsync, main clock signals MCLK, and data enable signals DE, for controlling the image display. The signal controller 600 processes the image signals R, G, and B pursuant to the operational conditions of the liquid crystal panel assembly 300. Based on the input image signals R, G, and B and the input control signals, the signal controller 600 generates gate control signals CONT1 and data control signals CONT2. The signal controller 600 transmits the gate control signals CONT1 to the gate driver 400, and the data control signals CONT2 and the processed image signals R′, G′, and B′ to the data driver 500.

The gate control signals CONT1 include scanning start signals STV for instructing the gate driver 400 to start the scanning of the gate on voltage Von, and at least one clock signal for controlling the output of the gate on voltage Von.

The data control signals CONT2 include horizontal synchronization start signals STH for instructing the data driver 500 of the data transmission of one pixel row, load signals LOAD for applying the relevant data voltages to the data lines D1-Dm, reverse signals RVS for inverting the polarity of the data voltage with respect to the common voltage Vcom (referred to hereinafter as “the polarity of the data voltage”), and data clock signals HCLK.

The data driver 500 receives image data R′, G′, and B′ with respect to one row of pixels in accordance with the data control signals CONT2 from the signal controller 600, and selects gray voltages from the gray voltage generator 800 corresponding to the respective image data R′, G′, and B′. In this way, the data driver 500 converts the image data R′, G′, and B′ into relevant data voltages for transmission to the data lines D1-Dm.

The gate driver 400 applies the gate on voltages Von to the gate lines G1-Gn in accordance with the gate control signals CONT1 from the signal controller 600 to turn on the switching elements Q connected to the gate lines G1-Gn. As a result, the data voltages applied to the data lines D1-Dm are applied to the relevant pixels through the turned-on switching elements Q.

The difference between the data voltage and the common voltage Vcom applied to the pixel is represented by the charge voltage of the liquid crystal capacitor C_{LC}, that is, by the pixel voltage. The liquid crystal molecules are reoriented depending upon the dimensions of the pixel voltages, and accordingly, the polarization of the light passing through the liquid crystal layer 3 is varied. The polarization variation is represented by the variation in light transmittance by way of the polarizers (not shown) attached to the panels 100 and 200.

When one horizontal cycle or 1H (a cycle of horizontal synchronization signals Hsync and data enable signals DE) is completed, the data driver 500 and the gate driver 400 repeat the same operation with respect to the next row of pixels. In this way, the gate on voltages Von are sequentially applied to all of the gate lines G1-Gn for one frame, thereby applying the data voltages to all the pixels. When one frame is terminated, the next frame starts, and the reverse signals applied to the data driver 500 are controlled such that the polarity of the data voltage applied to the respective pixels is opposite to that in the previous frame (the “frame inversion”). At this time, the polarities of the data voltages that flow through one data line may be inverted depending upon the characteristic of the reverse signals RVS even within one frame (for instance, a row inversion or a dot inversion), or the polarities of the data voltages applied to the pixels within a row may differ from each other (for instance, a column inversion or a dot inversion).

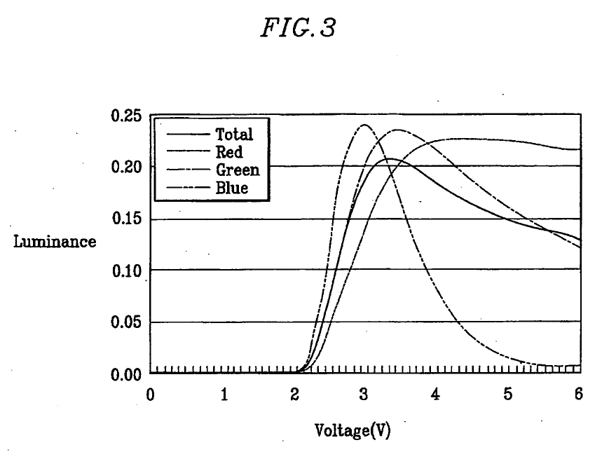

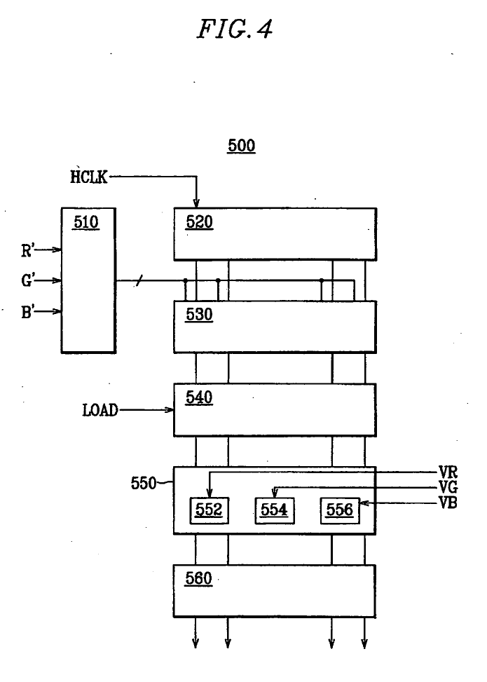

An LCD where the respective red R, green G, and blue B pixels are capable of expressing the maximum luminance according to an embodiment of the present invention will be described in detail with reference to FIGS. 3 and 4.

FIG. 3 is a graph illustrating the luminance characteristic of an LCD according to an embodiment of the present invention, and FIG. 4 is a block diagram of a data driver of an LCD according to an embodiment of the present invention.

The graph shown in FIG. 3 illustrates the luminance characteristic of an LCD with a normally black mode and a vertical alignment VA mode having a cell gap of 5 μm. The numerical value of luminance provided on the Y axis indicates the relative luminance.

As shown in FIG. 3, the gray voltage expresses the maximum luminance at 3.0V in the case of the blue color B, at 3.6V in the case of the green color G, and at 4.2V in the case of the red color R. Accordingly, the maximum value of the input image data corresponds to the gray voltage resulting in the maximum luminance (referred to herein as the maximum gray voltage). For example, in the case of a gray voltage value represented using 6 bits, a gray voltage value of 63 corresponds to the maximum gray voltage. The maximum gray voltage is divided pursuant to the luminance characteristics of the respective colors, and assigned to the respective gray data.

As shown in FIG. 4, the data driver 500 of the LCD according to the embodiment of the present invention includes a data controller 510, a shift register 520, a data register 530, a data latch 540, a digital-analog converter 540, and an output buffer 560.

The data controller 510 receives the processed image data R′, G′, and B′ from the signal controller 600, and transmits the processed image data R′, G′, and B′ to the data register 530. The shift register 520 sequentially stores the image data R′, G′, and B′ in the data register 530 in accordance with the data clock signals HCLK from the signal controller 600. The stored image data R′, G′, and B′ are transmitted to the data latch 540, and the data latch 540 transmits the image data R′, G′, and B′ to the digital-analog converter 550 in accordance with the load signals LOAD.

The digital-analog converter 550 includes a red digital-analog converter 552, a green digital-analog converter 554, and a blue digital-analog converter 556. The respective color digital-analog converters 552, 554, and 556 include gamma circuits (not shown) well adapted to the luminance characteristics of the respective colors shown in FIG. 3. The color digital-analog converters 552, 554, and 556 receive the maximum gray voltages VR, VG, and VB from the gray voltage generator 800 and image data R′, G′, and B′ from the data latch 540 and convert them into data voltages.

The output buffer 560 transmits data voltages to the relevant data lines such that they are held for one frame.

As described above, the data driver 500 receives the maximum gray voltages VR, VG, and VB for each of the respective colors, and has separate gamma circuits to express the maximum luminance of the respective colors, thereby enhancing the color representation.

With the luminance characteristic graph shown in FIG. 3 as an example, the luminance characteristic of the respective colors may be varied when the specification of the LCD is altered. Accordingly, the maximum gray voltages VR, VG, and VB of the respective colors may be varied so as to be optimized for the actual luminance characteristics of the LCD. For example, as described above, in FIG. 3, the maximum gray voltage corresponding to the maximum luminance of the color blue B is 3V. Thus, the gray voltage generator 800 generates a maximum gray voltage VB of 3V. In a different LCD device, if the maximum gray voltage corresponding to the maximum luminance of the color blue is 3.5V, the gray voltage generator 800 would generate a maximum gray voltage VB of 3.5V.

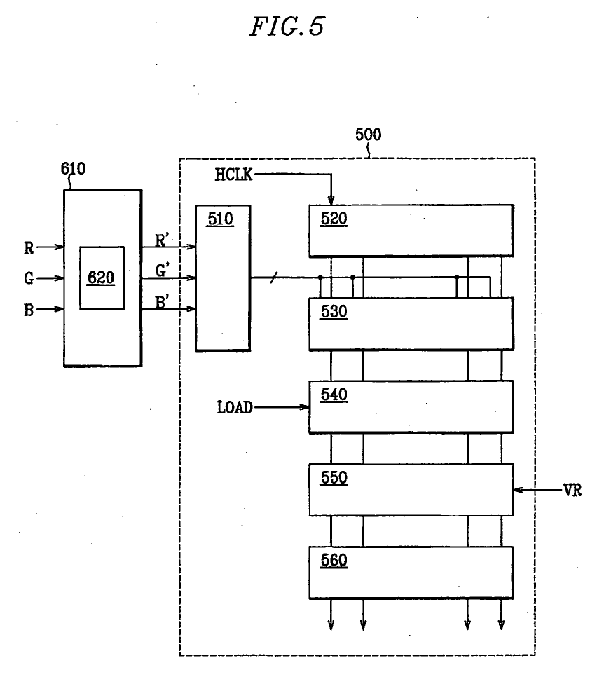

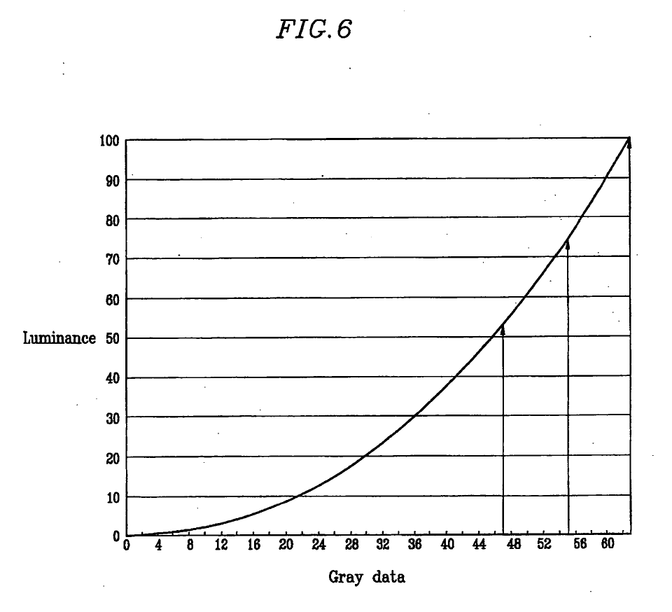

In addition, the gray voltage generator 800 may generate a plurality of gray voltages in addition to the maximum gray voltages VR, VG, and VB. The additional gray voltages may be applied to the respective color digital-analog converters 552, 554, and 556. An LCD capable of expressing the maximum luminance according to another embodiment of the present invention will be described in detail below with reference to FIGS. 5 and 6 in addition to FIG. 3.

FIG. 5 is a block diagram of a data corrector and a data driver of an LCD according to another embodiment of the present invention, and FIG. 6 is a graph illustrating a gamma curve with respect to the color red according to another embodiment of the present invention.

As shown in FIG. 5, an LCD according to another embodiment of the present invention includes a data corrector 610 and a data driver 500.

The data corrector 610 includes a lookup table 620. The data corrector 610 receives image data R, G, and B, and extracts the corrected image data R′, G′, and B′ corresponding to the image data R, G, and B from the lookup table 620 for transmission to the data driver 500. The data corrector 610 may be incorporated into the signal controller 600.

The data driver 500 includes a data controller 510, a shift register 520, a data register 530, a data latch 540, a digital-analog converter 540, and an output buffer 560.

The digital-analog converter 540 includes a gamma circuit (not shown) well adapted to the characteristics of the red gamma curve shown in FIG. 6, and receives the red maximum gray voltage VR. The digital-analog converter 540 converts the corrected image data R′, G′, and B′ into data voltages in accordance with the gamma curve. The digital-analog converter 540 may further receive a plurality of gray voltages and generate data voltages therefrom.

The gamma curve shown in FIG. 6 is a gamma curve generated based on the color red R, and the gray data is represented using 6 bits having gray values of 0-63. It will be now assumed that an LCD according to an embodiment of the present invention is driven by 6 bits of data, and for explanatory purposes, the input image data R, G, and B each with a data value of i are referred to as G_{R}(i), G_{G}(i) and G_{B}(i), and the gray data with the gray value of i in FIG. 6 as g(i).

The operation of the data corrector 610 will be now explained in detail.

The data corrector 610 corresponds the red image data R to the gray data in a one to one correspondence manner. Accordingly, G_{R}(0)=g(0), G_{R}(1)=g(1) . . . , G_{R}(63)=g(63). That is, the red corrected image data R′ are equal to the image data R. The gray data g(63) correspond to 4.2V being the red maximum gray voltage VR.

Meanwhile, the data corrector 610 corrects the green image data G such that the maximum input data G_{G}(63) corresponds to the gray data g(55). The gray data g(55) corresponds to 3.6V, which is the green maximum gray voltage VG.

In the case of medium gray values, two input data G are appropriately overlapped with each other such that they correspond to a single gray data, thereby correcting the image data G. For instance, the green image data G may correspond to the gray data as listed in Table 1 below. The lookup table 620 provides such a correspondence relation, and the data corrector 610 extracts the gray data corresponding to the input image data B from the lookup table 620, and transmits the gray data to the data driver 500 as the corrected image data G′.

In this way, the gray numbers of the input image data G are properly reduced to correct the image data G so that the green gamma curve well adapted in the gamma characteristic to the maximum gray voltage VG can be generated.

TABLE 1
G_{G}(i)→g(i)

| | |
|---|---|
| G_{G}(0) | g(0) |
| G_{G}(1) | g(1) |
| G_{G}(2) | g(2) |
| G_{G}(3) | g(3) |
| G_{G}(4) | g(4) |
| G_{G}(5) | g(5) |
| G_{G}(6) | g(6) |
| G_{G}(7) | g(6) |
| G_{G}(8) | g(7) |
| G_{G}(9) | g(8) |
| G_{G}(10) | g(9) |
| G_{G}(11) | g(10) |
| G_{G}(12) | g(11) |
| G_{G}(13) | g(12) |
| G_{G}(14) | g(12) |
| . . . | . . . |
| G_{G}(63) | g(55) |

Similarly, the data corrector 610 corrects the blue image data B such that the maximum input data G_{B}(63) corresponds to the gray data g(47). The gray data g(47) corresponds to 3.0V, which is the blue maximum gray voltage VB.

In the case of medium gray values, two input data B are appropriately overlapped with each other such that they correspond to a single gray data, thereby correcting the image data B. For instance, the blue image data B may correspond to the gray data as listed in Table 2 below. The lookup table 620 provides such a correspondence relation, and the data corrector 610 extracts the gray data corresponding to the input image data B from the lookup table 620, and transmits them to the data driver 500 as the corrected image data B′.

In this way, the gray numbers of the input image data B are appropriately reduced to correct the image data B so that the blue gamma curve well adapted in the gamma characteristic to the maximum gray voltage VB can be generated.

TABLE 2
G_{B}(i)→g(i)

| | |
|---|---|
| G_{B}(0) | g(0) |
| G_{B}(1) | g(1) |
| G_{B}(2) | g(2) |
| G_{B}(3) | g(2) |
| G_{B}(4) | g(3) |
| G_{B}(5) | g(4) |
| G_{B}(6) | g(5) |
| G_{B}(7) | g(5) |
| G_{B}(8) | g(6) |
| G_{B}(9) | g(7) |
| G_{B}(10) | g(8) |
| G_{B}(11) | g(8) |
| G_{B}(12) | g(9) |
| G_{B}(13) | g(10) |
| G_{B}(14) | g(11) |
| G_{B}(15) | g(11) |
| G_{B}(16) | g(12) |
| G_{B}(17) | g(13) |
| G_{B}(18) | g(14) |
| G_{B}(19) | g(14) |
| G_{B}(20) | g(15) |
| G_{B}(21) | g(16) |
| G_{B}(22) | g(17) |
| G_{B}(23) | g(17) |
| . . . | . . . |
| G_{B}(63) | g(47) |

The corrected image data G′ and B′ are provided in the lookup table 620 such that the maximum data of the input image data G and B correspond to the maximum gray voltages VG and VB, and the corrected image data G′ and B′ are extracted therefrom. As a result, the image data G and B are corrected in an easy manner, and accordingly, the maximum luminance of the respective colors may be expressed. Furthermore, as it is sufficient to apply a single maximum gray voltage VR, the conventional driving methods can be directly introduced without varying the designs of the data driver 500 and the liquid crystal panel assembly 300.

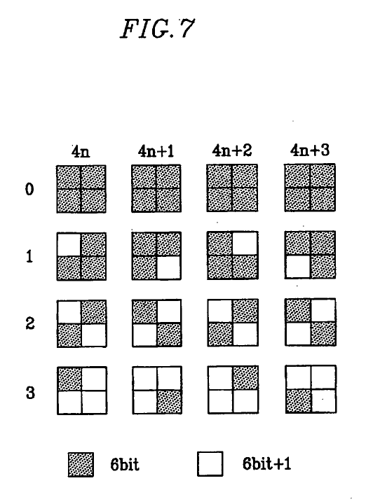

An LCD where the maximum luminance is expressed without reducing the number of gray values while maintaining a uniform inter-grays distance according to another embodiment of the present invention will be described below with reference to FIG. 7 in addition to FIG. 5. FIG. 7 illustrates a method of expressing 8 bits of conversion data using 6 bits of corrected image data according to another embodiment of the present invention.

The LCD includes the data corrector 610 and the data driver 500 shown in FIG. 5. The structure of the LCD is substantially the same as that related to the previous embodiment except for the correction operation of the data corrector 610, and hence, a detailed explanation thereof will be omitted.

In the case of a green image data G, a method of converting the input gray values of 0-63 into corrected image data G′ having a range of gray values of 0-55 will be now explained in detail.

Such a data correction provides a correspondence between the gray values of 0-63 to the gray values of 0-55. As a result, in the case where the data before the correction involves a gray value of 0, the data after the correction also involves a gray value of 0. However, in the case where the data before the correction involves a gray value of 63, the data after the correction corresponds to a gray value of 55. The intermediary gray values of 1-62 are mapped to the corrected gray values of 0-55 in accordance with a predetermined rule. In this case, the lookup table 620 provides the correspondence relations between the uncorrected gray values of 0-63 and the corrected gray values of 0-55. As a result, the data corrector 610 can easily and rapidly extract the relevant corrected gray values from the lookup table 620.

However, the gray values before the correction and the gray values after the correction do not correspond to each other in a one to one correspondence. Assume that the gray values of 0-63 linearly correspond to the gray values of 0-55. That is, if the data before the correction is x, the corrected image data is provided by x′=x×55/63. Thus, when the gray value of the image data G is “20,” the corrected gray value is 20×55/63=17.46. However, in order to express the value of 17.46 using 6 bits of image data, the numerical value below the decimal point would be discarded, and only the whole number of 17 would be expressed in 6 bits as “010001.”

However, when the decimal value is discarded, the gray value expression is not correct, and hence, dithering is made with respect thereto. For instance, the decimal value may be expressed by the average gray among the spatially neighboring pixels, or by the temporal mean value with respect to a predetermined pixel. These methods are called the spatial dithering and the temporal dithering, respectively.

As the precise expression of the decimal value using a digital value is inefficient, the decimal value may be approximately expressed using several values. That is, one bit, or two or more bits may be added to the 6 bits expressing the whole number value above the decimal point. These additional bits may be used to express the decimal value. For instance, assuming that the decimal value is y, where 0≦y<0.25, y is approximated as 0, where 0.25≦y<0.5, y is approximated as 0.25, where 0.5≦y<0.75, y is approximated as 0.5, and where 0.75≦y<1, y as 0.75. Such an approximated value may be expressed by increasing the number of data bits by two. For instance, 0, 0.25, 0.5 and 0.75 can be expressed by “00,” “01,” “10,” and “11,” respectively. In the case of a gray value of 20, the conversion value would be 17.46. Thus whole number portion of 17 may be expressed as “010001”, and the decimal portion of 0.46 is approximated as 0.25, which may be expressed in binary as “01”. Thus, the gray value of 20 can be expressed is binary as “01000101.”

FIG. 7 illustrates an example of producing 6 bits of corrected image data with respect to the respective pixels using the converted 8 bits of data.

As shown in FIG. 7, in the case where the lower two bits are “00,” the bits correspond to the numerical value of 0, and hence, only the upper 6 bits of data are provided to all four neighboring pixels. In the case where the lower two bits are “01,” the bits correspond to the numerical value of 0.25=1/4, and hence, only the upper 6 bits of data are provided to three of the four neighboring pixels, and the data where 1 is added to the upper 6 bits of data are given to the remaining one pixel. Consequently, the decimal portion of the average data of the four neighboring pixels becomes 0.25. Similarly, in the case where the lower two bits are “10” and “11,” the upper 6 bits of data are provided to the two pixels and one pixel, respectively. The data where 1 is added to the upper 6 bits of data are given to the remaining two pixels and three pixels respectively. A method of spatially expressing the decimal value in such a way may be referred to as spatial dithering.

However, when the same voltage is continuously applied to one pixel, a flickering image may result. Therefore, it is possible to express the decimal portion of the gray value as the average pixel data over a series of frames, and this is called the temporal dithering.

The combination of the expression of the spatial dithering and the temporal dithering is similar that shown in FIG. 7.

FIG. 7 illustrates the pixel arrangement made at four consecutive frames, that is, at the frames of 4n, 4n+1, 4n+2 and 4n+3.

With the dithering, the image data having a uniform inter-grays distance can be expressed without reducing the number of gray values, and the maximum luminance can be expressed.

With the case of the blue image data B, the gray values of 0-63 can be converted into gray values of 0-47 and expressed as described above, and hence, detailed explanation thereof will be omitted.

This conversion is described herein in relation to the case where the image data is represented using 6 bits, but even in the case where the image data are 8 bits, the same expansion can be made.

The description herein relates to normally black mode LCDs, but the structure according to the present invention may also be similarly applied to normally white mode LCDs as well.

Furthermore, cyan, magenta, and yellow may be used as the three primary colors in addition to the colors of red R, green G, and blue B. In addition, the inventive structure can be similarly applied to pixels of four or more colors.

As described above, different maximum gray voltages may be applied for the respective colors so that the maximum luminance of the respective colors can be expressed, and the color representation can be enhanced.

While the present invention has been described in detail with reference to the preferred embodiments, those skilled in the art will appreciate that various modifications and substitutions can be made thereto without departing from the spirit and scope of the present invention as set forth in the appended claims.

What is claimed is:

1. A display device comprising:
a plurality of gate lines;
a plurality of data lines crossing the gate lines for transmitting gray voltages as data voltages corresponding to image data, said gray voltages selected from a plurality of gray voltages; and
a plurality of pixels coupled to the gate and the data lines for receiving the data voltages;
wherein:
the pixels comprise first color pixels, second color pixels, and third color pixels,
the first color pixels express a maximum luminance upon application of a first voltage having a maximum value among the gray voltages,
the second color pixels express a maximum luminance upon application of a second voltage,
the third color pixels express a maximum luminance upon application of a third voltage, said second and third voltages being less than the first voltage.

2. The display device of claim 1 wherein the plurality of gray voltages comprise a set of first, second, and third gray voltages having maximum values of the first, the second, and the third voltages, respectively.

3. The display device of claim 2 further comprising:
a signal controller for receiving and signal-processing the image data and transmitting the processed data; and
a data driver for receiving the processed data from the signal controller and converting the processed data into the data voltages for application to the data lines.

4. The display device of claim 3 wherein the first color pixels comprise red pixels.

5. The display device of claim 3 further comprising a gray voltage generator for generating and applying the first, second, and third voltages to the data driver.

6. The display device of claim 5 wherein the data driver comprises first, second, and third digital-analog converters for generating the first, second, and third gray voltages, respectively, based on the first, second, and third voltages from the gray voltage generator, respectively.

7. The display device of claim 3 wherein:
the image data comprise first, second, and third image data corresponding respectively to the first, second, and third color pixels; and
the number of gray values corresponding to the second and the third image data is less than the number of gray values corresponding to the first image data.

8. The display device of claim 3 further comprising a gray voltage generator for generating and applying the first voltage to the data driver, wherein the data driver comprises a digital-analog converter for converting the processed first, second, and third image data into the data voltages based on the first voltage from the gray voltage generator.

9. The display device of claim 8 further comprising a data corrector for correcting the second and the third image data each with the maximum gray value into first and second gray data corresponding to the second and the third voltages, respectively.

10. The display device of claim 9 wherein the data corrector relates the second and the third image data to a single gray data.

11. The display device of claim 10 wherein the data corrector comprises a lookup table providing a correspondence relation between the second and third image data and the gray data.

12. The display device of claim 9 wherein the data corrector corrects and dithering-processes the second and the third image data such that the second and the third image data have an output gray range less than the input gray range.

13. A method of driving a display device comprising a plurality of first to third color pixels, the method comprising the steps of:
generating a plurality of gray voltages;
receiving first to third image data corresponding to the respective first to third color pixels;
signal-processing the first to third image data; and
applying gray voltages as data voltages corresponding to the first to the third image data, said gray voltages being selected from a plurality of gray voltages;
wherein the first color pixels express a maximum luminance upon application of a first voltage having a maximum value among the gray voltages, the second color pixels express a maximum luminance upon application of a second voltage, and the third color pixels express a maximum luminance upon application of a third voltage, said second and third voltages being less than the first voltage.

14. The method of claim 13 wherein the step of generating the gray voltages comprises a sub-step of generating first to third gray voltages with the maximum values of the first to the third voltages, respectively.

15. The method of claim 13 wherein the step of processing the first to the third image data comprises a sub-step of correcting the second and the third image data each with the maximum gray value into second and third gray data corresponding to the second and the third voltages, respectively.
